(19) United States
(12) Patent Application Publication
(10) Pub. No.: US 2018/0009934 A1
(43) Pub. Date: Jan. 11, 2018

(54) HIGH DIELECTRIC BREAKDOWN STRENGTH RESINS

(71) Applicant: JOHN L. LOMBARDI, Tucson, AZ (US)

(72) Inventor: JOHN L. LOMBARDI, Tucson, AZ (US)

(21) Appl. No.: 15/646,979

(22) Filed: Jul. 11, 2017

Related U.S. Application Data
(60) Provisional application No. 62/360,874, filed on Jul. 11, 2016.

(51) Int. Cl. C08G 18/62; C08F 216/08; C08F 8/14; C09D 125/08; C08L 75/04

(52) U.S. Cl. CPC C08G 18/6212; C09D 125/08; C08L 75/04; C08F 8/14; C08F 216/08; C08F 2800/20

(57) ABSTRACT

A method to prepare an oligomer which includes a plurality of pendent alkenyl groups, where the method reacts a copolymer formed by copolymerizing styrene and allyl alcohol comprising a polyhydroxy oligomer wherein n is between about 3 and about 50, and having a structure:

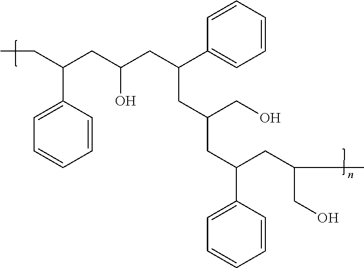

with an isocyanate having a structure:

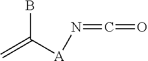

to give a urethane-modified copolymer having a structure:

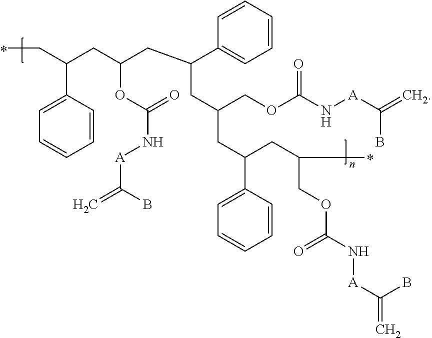

### CROSS REFERENCE TO RELATED APPLICATION

This Non-Provisional Patent Application claims priority to a Provisional Patent Application filed on Jul. 11, 2016, and having Ser. No. 62/360,874, which is hereby incorporated herein by reference.

### FIELD OF THE INVENTION

Applicant's disclosure relates to polymeric material comprising a high dielectric breakdown strength.

### BACKGROUND OF THE INVENTION

A need exists for better performing dielectrics for a variety of demanding electronic applications including high frequency and high voltage components such as those utilized in radio frequency and high power microwave (HPM) systems. A burgeoning need also exists for better performing dielectrics in low loss, flexible electronics technologies.

### SUMMARY OF THE INVENTION

Photocurable stereolithographic (SLA) resins were initially developed in lieu of 3D printable fused deposition modeling (FDM) thermoplastic feedstock given that the former can typically be printed at much higher dimensional resolution and/or accuracy and also lend themselves towards easier compositional “tuning” adjustment than the latter approach. Furthermore, low viscosity resins also offer the ability to be photo or thermally cast and cured within conventional low cost tooling or flexible electronics printing means, thereby offering an alternative means for prototype production in lieu of SLA 3D printing methods.

### DETAILED DESCRIPTION OF THE PREFERRED EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is advantageous to develop chemical compositions that are capable of producing complex-shaped electrical components by curing high dielectric breakdown strength resin formulations using 3D Printing methods. 3D Printing methods offer an attractive means for rapidly manufacturing complicated geometries.

Unfortunately conventional printing processes are only capable of producing inferior parts from acrylic resins which are moisture sensitive and have inherently low dielectric breakdown strength. Initial efforts were directed to developing a low viscosity resin formulation which could be efficiently addition polymerized into a high molecular weight polymer. Addition polymerization routes were selected on the basis that they typically proceed cleanly and efficiently and do not produce reaction by-products which would otherwise need to be removed from the 3D layers during 3D printing operations.

Target properties include: low inherent viscosity (η<0.8 centipoise); low surface tension (e.g. γ<35 dyne−cm⁻¹; ensuring facile wettability and accurate deposition of adjacent 3-D printed layers); hydrophobicity (H₂O sorption promotes undesired treeing and premature dielectric breakdown; low acute toxicity (L_{D}50>2000 mg/Kg body weight); very low vapor pressures (e.g. 14-fold lower than conventional styrene monomer, a consideration for operator exposure given open SLA printer feedstock baths); and substituted-styrene monomers were inexpensive, costing about 100 fold less than competing conventional fluorinated dielectric polymer resins, and are commercially available in bulk 55 gallon drum quantities.

Photocurable stereolithographic resins were developed in lieu of 3D printable fused deposition modeling thermoplastic feedstock because the former can be printed at much higher dimensional resolution and/or accuracy. In addition, photocurable stereolithographic resins can be compositionally “tuned” to maximize desirable properties. Furthermore, low viscosity resin formulations can be thermally cured using conventional low cost tooling, thereby offering an alternative means for prototype production in lieu of using 3D printing methods.

The goal to formulate a resin formulation comprising a polyfunctional unsaturated oligomer blended with low viscosity diluent monomers. By varying the ratio between the oligomer and the diluent(s), it would be possible to prepare photocurable formulations compatible with conventional SLA type 3D printers or flexible electronics coating and printing approaches.

Initial efforts focused upon developing a low viscosity formulation which could be efficiently addition polymerized into a high molecular weight polymer. Addition polymerization routes were selected on the basis that they typically proceed cleanly and efficiently and do not produce reaction by-products which would otherwise need to be removed from the 3D layers during 3D printing operations.

Both styrenic and maleimide derivatives readily addition polymerize to high molecular weight polymer products. Alkyl substituted styrenics, particularly 4-tert butyl styrene (TBS) 1 and para-methyl styrene (PMS) 2 were evaluated as candidate reactive diluents.

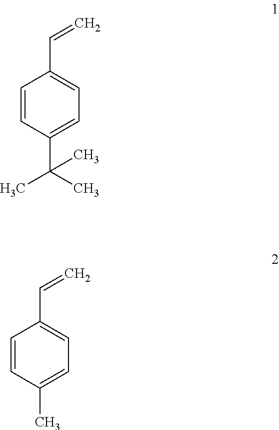

Substituted styrenes 1 and 2 each comprise the following properties:

Low inherent viscosity (η<0.8 centipoise);

low surface tension (e.g. γ<35 dyne−cm−1; ensuring facile wettability & accurate deposition of adjacent 3-D printed layers);

hydrophobicity (H2O sorption promotes undesired treeing & premature dielectric breakdown);

low acute toxicity (LD50>2000 mg/Kg body weight);

very low vapor pressures (e.g. 14-fold lower than conventional styrene monomer; a consideration for operator exposure given open SLA printer feedstock baths);

substituted styrene 1 is available in commerce costing about 100 fold less than conventional fluorinated dielectric polymer resins.

Further, the physical and reactivities of these alkyl substituted styrenic monomers 1 and 2 differ significantly from conventional styrene as can be seen from the data within the Table 1, below. Monomers 1 and 2 comprise properties necessary for a candidate 3D printing resin including low volumetric shrinkage and exotherm upon addition polymerization high thermal and volumetric shrinkage stresses can accumulate within 3D printed part layers and detract from the overall integrity and dimensional accuracy of the printed part.

TABLE 1
Difference in Monomer Properties between
compound 1 and 2 versus Styrene

| Monomer | 1 | 2 | STYRENE |
|---|---|---|---|
| Viscosity η (cps @ 40° C.) | 0.5 | 0.79 | 0.72 |
| Surface Tension γ (dyne-cm⁻¹ | 29 | 34 | 32 |
| @ 25° C.) | | | |
| Toxicity LD₅₀ (mg/Kg) | >2000 | >5000 | >2000 |
| Monomer Vapor Pressure (atm | 0.00132 | 0.00526 | 0.0184 |
| @ 40° C.) | | | |
| Heat of Polymerization (BTU/lb.) | 191 | 244 | 288 |
| Volume % Polymerization | 7.3 | 13 | 20.6 |
| Shrinkage | | | |
| Polymer Vicat Heat Distortion | 145 | 119 | 95 |
| Temp (° C.) | | | |

Styrenic and polyimide polymers exhibit high dielectric breakdown field strengths (e.g. polystyrene>19 MV/m. The significant breakdown strength associated with styrenic polymers has been attributed to the presence of aromatic rings within its chemical structure. This enables the polymer to rapidly dissipate applied electrical field energy and resultant corona via formation of various stable primary and secondary aromatic radicals; ultimately preventing polymer chain scission and material breakdown.

Similarly, polyimides were also selected as candidate 3D printable copolymer resin components given their outstanding thermal, mechanical and electrical properties. Copolymerization between substituted styrenes 1 and 2 and a maleimide 8. In certain embodiments, unsubstituted maleimide is used, i.e. R3 is hydrogen. In certain embodiments, R3 is phenyl, i.e. N-Phenyl Maleimide. In certain embodiments, R3 is cyclohexyl. In certain embodiments, R3 is N-linear alkyl.

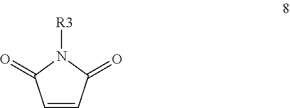

Applicant developed 3-D printing resins using the above low viscosity alkyl substituted styrenic monomer diluents blended with a urethane modified oligomer. In certain embodiments, Applicant utilizes an oligomeric polyol formed by chain growth polymerization of one or more unsaturated monomers, wherein at least one of those monomers comprises a hydroxyl moiety.

In certain embodiments, Applicant utilizes an alternating copolymer formed by copolymerizing styrene and allyl alcohol to form a poly-hydroxy oligomer 3, wherein n is between about 3 and about 50.

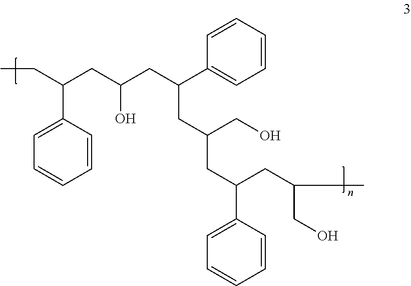

Applicant then reacts alternating copolymer 3 with one or more isocyanato alkenes, such as isocyanato alkene 4, wherein A is selected from the group consisting of substituted phenyl and —CO—O—CH₂—CH₂—, and wherein B is alkyl.

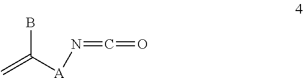

In certain embodiments, isocyanato alkene 4 comprises a substituted styrene 5. In other embodiments, isocyanato alkene 4 comprises a substituted methacrylate 6.

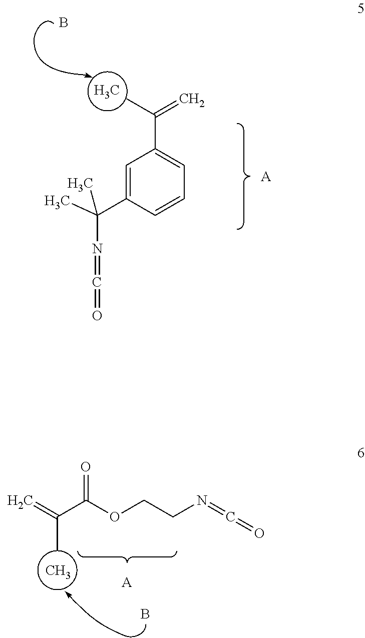

In certain embodiments, Applicant reacts polyol 3 with isocyanato alkene 4 to form a urethane modified copolymer 7, wherein n is between about 3 and about 50.

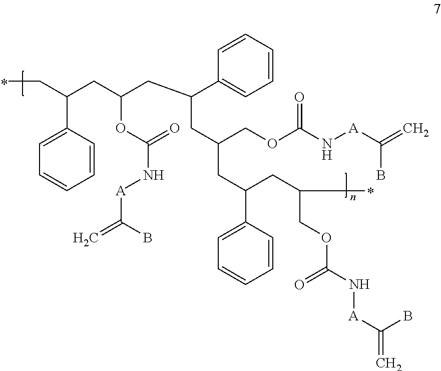

By varying the ratio between substituted styrenes 1 and/or 2 and oligomer 7, Applicant produced formulations having adequate viscosities and curing characteristics suitable for thermal casting and photocurable 3D printing operations respectively.

Various candidate resin blends between styrenes 1 and/or 2 and oligomer 7, were then formulated, cast and thermally cured into about 11.43 cm (e.g. about 4.5 inch) diameter by about 0.5 mm thick test discs. The resins were formed by curing oligomer 7 dissolved in a mixture of substitute styrenes 1 and 2. Initial testing was performed by casting the resin discs between glass plates followed by thermally initiated addition polymerization to cure the resin into the desired test disc. These discs served as a baseline for the bulk cured candidate dielectric polymer material which would later be compared to corresponding resin parts processed via the SLA method.

Thermal curing was accomplished via addition of an 0.8 weight percent dilauroyl peroxide (LPO) free radical initiator added to the resin followed by heating the glass plate mold for 30 minutes within an isothermal air convection oven operating at 111° C.

TABLE 2

| Component | Function | WEIGHT PERCENT |
|---|---|---|
| MONOMER 1 | Reactive Diluent | 31.2 |
| MONOMER 2 | Reactive Diluent | 26.4 |
| Polystyrene-co-Allyl | Oligomer Precursor | 24.8 |
| Alcohol 3 | | |
| dimethyl meta-isopropenyl | Oligomer Precursor | 17.6 |
| benzyl isocyanate 5 | Monomer | |

In certain embodiments, Applicant's composition includes tris (2-hydroxyethyl) isocyanurate triacrylate 9. Table 3 summarizes the components, and weight percentages for same, utilized in a thermally-cured embodiment.

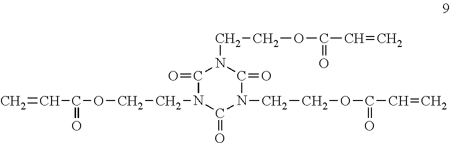 [SMILES: C=CC(=O)OCCn1c(=O)n(CCOC(=O)C=C)c(=O)n(CCOC(=O)C=C)c1=O]

TABLE 3

| | | | |
|---|---|---|---|
| MONOMER 1 | 21.14% | Trifunctional Monomer 9 | 12.01% |
| MONOMER 2 | 17.90% | Substituted Maleimide 8 | 12.63% |
| | | R3 = Phenyl | |
| Oligomer 3 | 16.81% | Substituted Maleimide 8 | 6.53% |
| | | R3 = Hydrogen | |
| Isocyanate 5 | 11.93% | Lauryl Peroxide | 1.05% |
| | | Initiator | |

Table 4 recites a monomer mixture in weight percentage that is substantially the same as the monomer mixture in weight percentage of Table 3. Table 4 represents a photo-cured formulation.

TABLE 4

| | | | |
|---|---|---|---|
| MONOMER 1 | 21.29% | Trifunctional Monomer 9 | 12.09% |
| MONOMER 2 | 18.02% | Substituted Maleimide 8 | 12.42% |
| | | R3 = Phenyl | |
| Oligomer 3 | 16.93% | Substituted Maleimide 8 | 6.42% |
| | | R3 = Hydrogen | |
| Isocyanate 5 | 12.01% | Irgacure 819 | 0.83% |
| | | Photoinitiator | |

Thermal analysis was conducted upon both thermally cured as well as photocured resins to determine the glass transition temperatures of the resultant polymers at a 10° C./minute minute scanning rate.

No significant difference was observed between the glass transition temperatures measured for the thermal versus photocured polymer resin samples. Both materials had high glass transition temperatures (Tg) of approximately 268° C. A slight endotherm at 341° C. was attributed in these DSC plots to evaporation of an unreactive impurity present within the original 4-tertbutyl styrene monomer starting material. The high Tg of the polymers was desirable for an electronics application since this indicated that the polymer would presumably remain dimensionally stable and resist degradation when subjected to elevated temperatures often associated with the operation of high power circuits.

Applicant developed a low viscosity, hydrophobic monomer mixture formulation that produced dielectric components suitable for high power applications. This resin was shelf stable even after standing at 0 degrees Celsius for several hours and was successfully 3D Printed into polymer test specimens.

In this embodiment, Applicant's monomer mixture further comprises N-Vinyl Caprolactam 9. Table 5 recites the components and weight percentages for same for a monomer mixture that includes N-Vinyl Caprolactam 9.

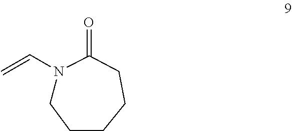

TABLE 5

| Component | Concentration (Wgt. %) |
|---|---|
| MONOMER 1 | 19.06 |
| MONOMER 2 | 16.13 |
| Isocyanate 5 | 10.76 |
| Oligomer 3 | 15.16 |
| Lactam 9 | 18.98 |
| Substituted Maleimide 8 | 9.74 |
| R3 = Phenyl | |
| Substituted Maleimide 8 | 4.97 |
| R3 = Hydrogen | |
| Genorad 20 (Rahn USA) | 0.20 |
| Irgacure 819 (BASF) | 5.0 |

Test coupons formed using the formulation of Table 5 exhibited an unusual combination of thermal and electrical properties, including a dielectric constant and 10 GHz loss tangent of 2.700 and 0.00238 respectively, while exhibiting a high glass transition temperature (Tg) of 268° C. (See Table 6 below for results summary.) The resin formed from the components of Table 5 compares quite favorably to commercial, high performance polytetrafluoroethylene insulator sheet of identical thickness. Such commercial polytetrafluoroethylene insulator materials exhibited a 2.107 dielectric constant, 0.00100 loss tangent and a 115° C. Glass Transition Temperature (Tg) respectively.

Table 6 recites properties measured for the resin formed using the components of Table 5.

TABLE 6

| Property | Value |
|---|---|
| Dielectric Constant ε | 2.70 ^{a} |
| Loss Tangent (10 GHz) δ | 0.00238 ^{a} |
| Dielectric Breakdown Strength | >140 KV/mm (cast) ^{b} |
| (ASTM D149) | |
| Dielectric Breakdown Strength | >80 KV/mm (3D Printed) ^{b} |
| (ASTM D149) | |
| Glass Transition Temperature (Tg) | 268° C. ^{c} |

^{a} Professor Hao Xin at the University of Arizona Department of Electrical and Computer Engineering, Dielectric Testing performed upon 2.48 mm thick discs using an Agilent E8361A Vector Network Analyzer outfitted with an Agilent 85072A 10 GHz Dielectric Resonator Measurement kit.
^{b} 0.5 mm thick test specimens immersed within Shell Diala S2 ZX-A insulating oil using a Hipotronics Model 880PLA power supply
^{c} Measured using Mettler Toledo DSC 1 Differential Scanning Calorimeter operating at a 10° C./minute scanning rate

In certain embodiments, Applicant substitutes Vinylphosphonic acid dimethyl ester 10 for the N-Vinyl Caprolactam 9.

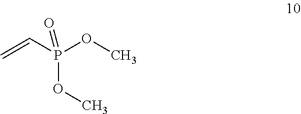

Table 7 recites components for this embodiment of Applicant's monomer mixture.

TABLE 7

| Component | WEIGHT PERCENT |
|---|---|
| MONOMER 1 | 19.805 |
| MONOMER 2 | 16.758 |
| Isocyanate 5 | 11.172 |
| Oligomer 3 | 15.743 |
| Vinyl Phosphic Acid Dimethyl Ester | 16.043 |
| ‘ [symbol] ’ | |
| Substituted Maleimide 8 | 10.119 |
| R3 = Phenyl | |
| Substituted Maleimide 8 | 5.16 |
| R3 = Hydrogen | |
| Genorad 20 Photostabilizer | 0.200 |

[symbol]

indicates data missing or illegible when filed

In certain embodiments, a chain growth polymer comprising one or more terminal hydroxyl groups, such as and without limitation, polyphenylene oxide 11 wherein n is greater than 1 and less than about 100,000, is reacted with isocyanate 5 using a dibutyl tin dilaurate (DBTDL) catalyst to give an oligomer 12 useable in a chain growth polymerization. In certain embodiments, Applicant replaces oligomer 3 with oligomer 12 in his monomer mixture.

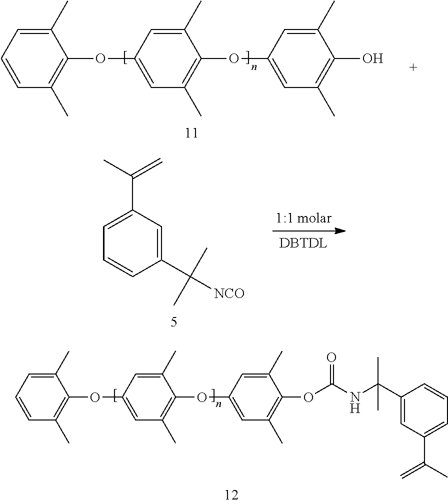

In certain embodiments, a polymer comprising a terminal hydroxyl group, such as and without limitation, polyphenylene oxide 14 wherein m is greater than 1 and less than about 100,000 and wherein p is greater than 1, and less than about 100,000, and wherein R3 is selected from the group consisting of alkyl, aryl, and oxyalkyl, is reacted with isocyanate 5 using DBTDL catalyst to give an oligomer 15 useable in a chain growth polymerization. In certain embodiments, Applicant replaces oligomer 3 with oligomer 15 in his monomer mixture.

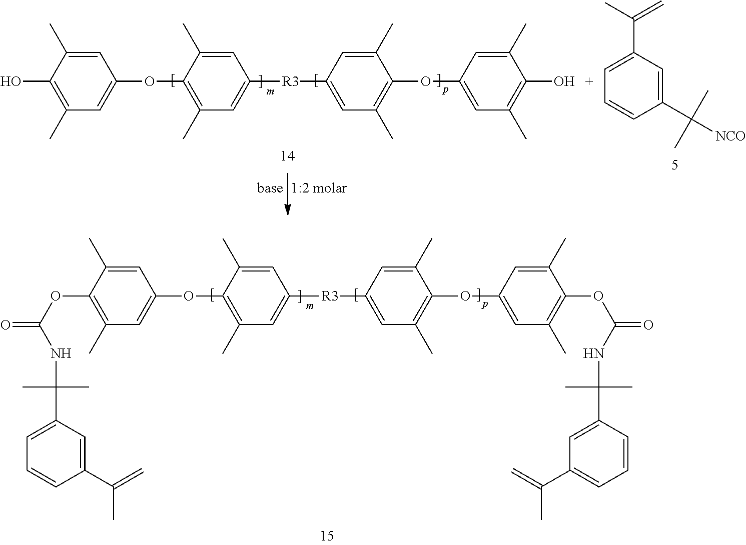

In certain embodiments, a polymer comprising a terminal hydroxyl group(s), such as and without limitation, polyphenylene oxide 11 wherein n is greater than 1 and less than about 100,000, is reacted with Vinyl Benzyl Chloride 13 to give an oligomer 14 useable in a chain growth polymerization. In certain embodiments, Applicant replaces oligomer 3 with oligomer 14 in his monomer mixture.

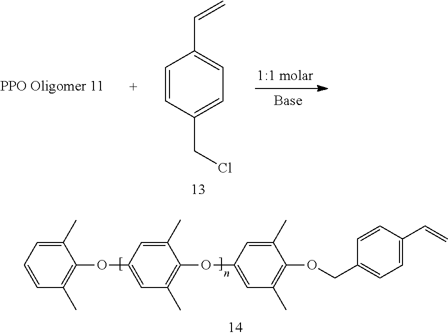

In certain embodiments, a chain growth polymer comprising a terminal hydroxyl group, such as and without limitation, polycarbonate diol 16, wherein n is greater than 1 and less than about 6. In certain embodiments, R₁ is hydrogen. In other embodiments, R₁ is NH-linear alkyl. In certain embodiments, R₂ is alkyl.

Further, polycarbonate diol 16, wherein n is between 1 and about 50, is reacted with isocyanate 5 using DBTDL catalyst to give an oligomer 17 useable in a chain growth polymerization. In certain embodiments, Applicant replaces oligomer 3 with oligomer 17 in his monomer mixture at various weight percentages, wherein R1 and R2 are selected from the group consisting of alkyl. In some embodiments, the weight percentage of oligomer 17 ranges from about 5% to about 50%.

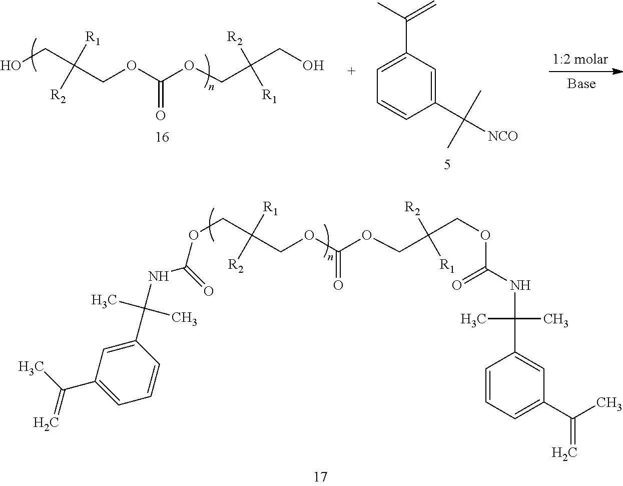

Table 8 recites components and a preferred embodiment of the weight percentage of oligomer 17 for this embodiment of Applicant's monomer mixture comprising oligomer 17.

TABLE 8

| Compound | MW g/mol | Mass Weight % |
|---|---|---|
| oligomer 17 | 1186.3 | 31.19 (22.15% Oxymer HD112 |
| | | Polycarbonate Diol, 9.04% |
| | | Isocyanate 5) |
| Monomers 1 | 160.26 | 27.77 |
| Monomers 2 | 118.18 | 19.32 |
| Substituted Maleimide 8 | 97.07 | 11.06 |
| R₃ = Hydrogen | | |
| Substituted Maleimide 8 | 173.17 | 10.66 |
| R₃ = Phenyl | | |

Test coupons formed using the formulation of Table 8 exhibited an unusual combination of thermal and electrical properties, such as having a dielectric breakdown strength of 222 kV/mm, having a 10 GHz loss tangent of 0.0017, and displaying good flexibility.

In certain embodiments, substituted maleimide 8, R₃=Hydrogen can be replaced by equimolar amount of substituted maleimide 8, R3=Phenyl. Table 9 recites components of a preferred weight percentage of oligomer 17 for this embodiment of Applicant's monomer mixture comprising oligomer 17.

TABLE 9

| Compound | Mass Weight % |
|---|---|
| oligomer 17 | 20.4 |
| Isocyanate 5 | 8.32 |
| Monomers 1 | 25.5 |
| Monomers 2 | 17.8 |
| Substituted Maleimide 8 | 28.0 |
| R₃ = Phenyl | |

In other embodiments, polycarbonate diol 16 is reacted with isocyanate methacrylate 6 using DBTDL catalyst to give an oligomer 18 useable in a chain growth polymerization. In certain embodiments, Applicant replaces oligomer 3 with oligomer 18 in his monomer mixture at various weight percentages.

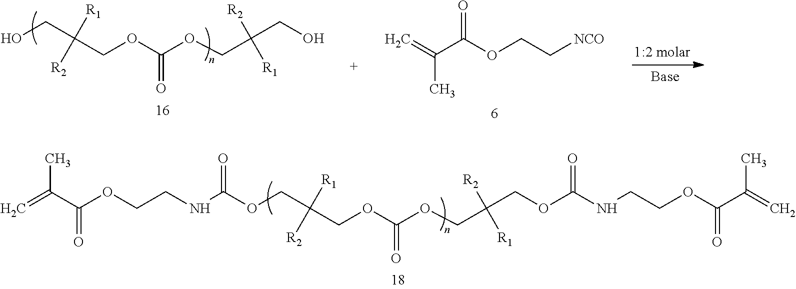

In yet other embodiments, polycarbonate diol 16 is reacted with isocyanate 19 using DBTDL catalyst to form an oligomer 20.

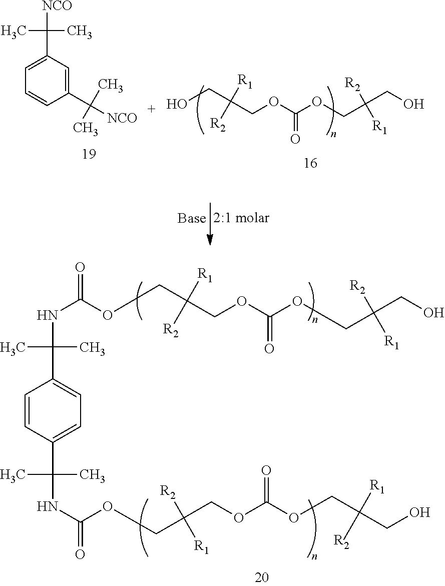

Further, oligomer 20 is reacted with isocyanate 5 using DBTDL catalyst to give an oligomer 21 useable in a chain growth polymerization.

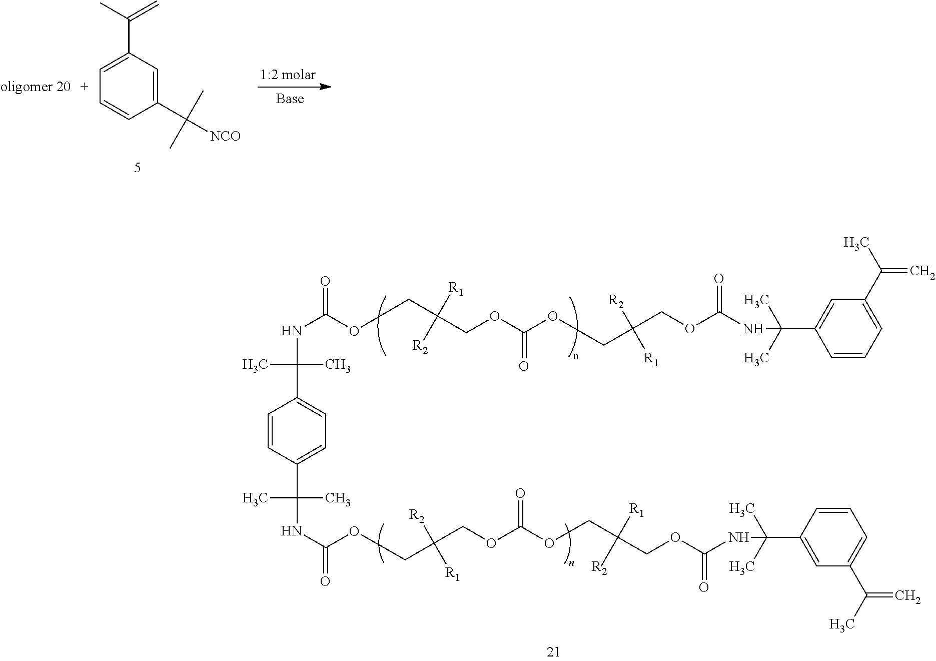

In yet further embodiments, aromatic polycarbonate (PC) comprising a structure 22, wherein n is between about 2 and about 500,

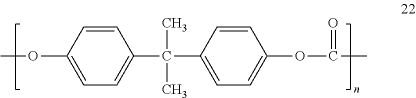

is reacted with hydroxy-substituted amines comprising a structure 23,

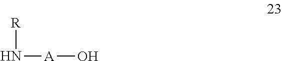

wherein R is selected from the group consisting of hydrogen and alky, and wherein A is alkyl. In general, the hydroxy-substituted amines are able to cleave carbonate moieties in oligomer 22 comprising the structure 22 at room temperature. In a preferred embodiment, without limitation, when R is hydrogen and A is ethyl, structure 23 is ethanolamine. In another preferred embodiment, without limitation, when R is hydrogen and A is propyl, structure 23 is propanolamine. In yet another preferred embodiment, without limitation, when R is methyl and A is ethyl, structure 23 is N-Methyl ethanolamine. In yet another preferred embodiment, without limitation, when R is hydrogen and A is phenyl, structure 23 is aminophenol.

Further, oligomer 22 is reacted with hydroxy- substituted amine 23 in the following illustrated scheme to form an oligomer 24, wherein m is between about 2 and about 250.

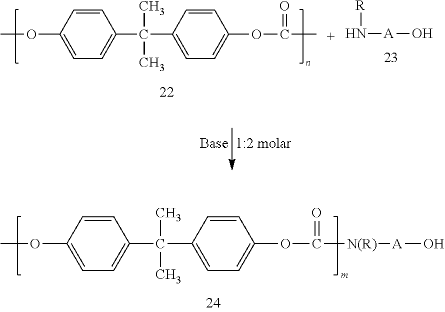

Moreover, oligomer 24 is reacted with isocyanate 5 using DBTDL catalyst to give an oligomer 25 useable in a chain growth polymerization.

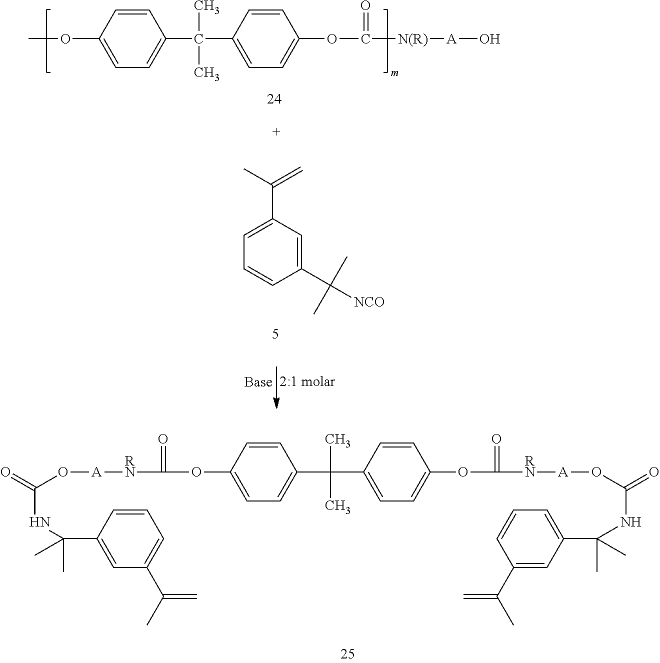

In certain embodiments, Applicant replaces oligomer 3 with oligomer 25 in his monomer mixture at various weight percentages. In other embodiments, oligomers 18, 21, and 25 can be blended by different weight percentages in any combination thereof to form a blended oligomer mixture, which can replace oligomer 3.

In certain embodiments, a chain growth polymer comprising a terminal hydroxyl group, such as and without limitation, caprolactone acylate 26, is used to replace oligomer 3. Table 11 recites components and a preferred weight percentage for this embodiment.

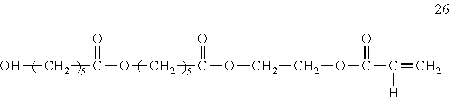

TABLE 10

| Compound | MW g/mol | Mass Weight % |
|---|---|---|
| Caprolactone acylate 26 | | 34.84 |
| Monomers 1 | 160.26 | 26.18 |
| Monomers 2 | 118.18 | 18.31 |
| Substituted Maleimide 8 | 97.07 | 10.58 |
| R₃ = Hydrogen | | |
| Substituted Maleimide 8 | 173.17 | 10.09 |
| R₃ = Phenyl | | |

Test coupons formed using the formulation of Table 10 exhibited a dielectric breakdown strength of 90 kV/mm, a 10 GHz loss tangent of 0.0137, and good flexibility.

Applicant developed 3-D printing resins using the above low viscosity alkyl substituted styrenic monomer(s), in combination with an imide 8 (R3=H), or imide 8 (R332 Phenyl), and/or imide 9. In certain embodiments, Applicant's 3-D printing resin further comprises a triene formed by reaction between trimercaptotriazine 27 and 3 equivalents of 4-Vinylbenzyl Chloride 28 to form triene 29.

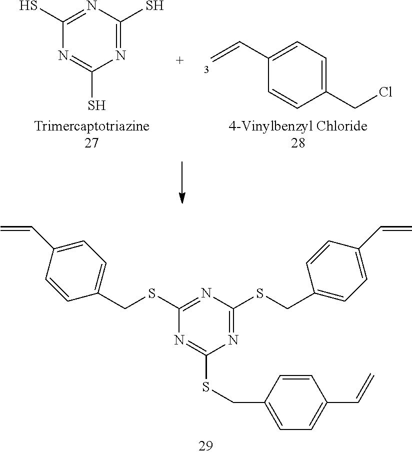

The following Example sets forth Applicant's synthesis of Triene 29. This Example should not be taken as limiting. Rather, the claims herein set forth the embodiments of Applicant's disclosure.

### EXAMPLE 1

The reaction between vinyl benzyl chloride 28 and trimercaptotriazine 27 was conducted within alcoholic potassium hydroxide (KOH) medium. In particular, trimercaptotriazine 10 was added to methanolic KOH (e.g. 4.9 g KOH/73.5 g methanol) solution. Then 13 g of vinyl benzyl chloride 28 was added dropwise in a 3:1 molar equivalent (11:10) stoichiometric ratio to the solution while stirring at room temperature.

Following vinyl benzyl chloride addition, the solution was then heated to approximately 50° C., where it stirred and reacted for a few hours. Thereafter, 33 g of toluene was added, and the solution heated to approximately 63° C. The amount of toluene added was such that it formed a binary azeotrope with methanol (azeotrope: 31 weight percent toluene/69 weight percent methanol bp 63.8° C.).

The contents of the flask were filtered while hot to separate a KCI precipitate from the solution. The solution filtrate was placed in a freezer overnight (held at −25° C.) whereby Triene 12 precipitated and was subsequently recrystallized from the liquid. The Triene 12 product was filtered while cold and vacuum dried. FIGS. 1, 2, and 3, comprising FTIR Spectra, were taken from Triene 29 and compared to FTIR spectra of starting materials 10 and 11.

Applicant utilizes a similar synthetic scheme to prepare a tri-methyl methacrylate substituted triazine 31 using trimercaptotriazine 27 in combination with glycidyl methyl methacrylate 30 using a tertiary amine catalyst.

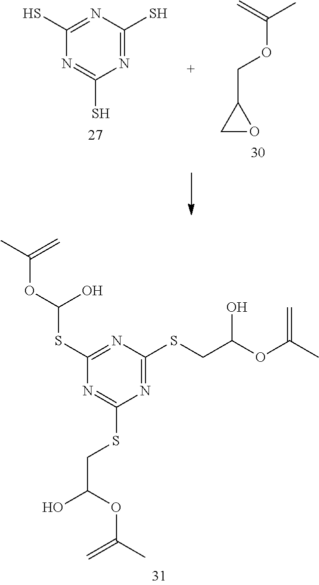

Applicant utilizes a similar synthetic scheme to prepare a tri-isocyanatoethyl-substituted triazine 33 using trimercaptotriazine 27 in combination with 2-isocyanatoethyl methacrylate 32.

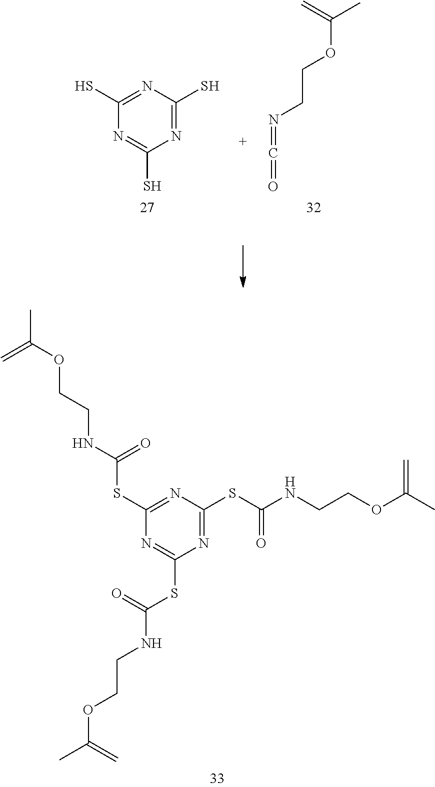

Table 11 summarizes formulations prepared and tested.

TABLE 11

| | Formulation | Formulation | Formulation | Formulation |
|---|---|---|---|---|
| Component | 1 | 2 | 3 | 4 |
| Phenylmaleimide | 24.44 | 27.49 | 27.85 | 28.99 |
| Maleimide | 12.47 | 14.03 | 14.04 | 14.79 |
| Tert-Butylstyrene | 43.42 | 48.33 | 52.30 | 51.18 |
| TRIENE 29 | 19.95 | 9.96 | 5.81 | 5.03 |

Tables 12, 13, 14, and 15, summarize certain dielectric properties measured from resins prepared using the formulations of Table 11. The “Q”, “db”, “Real”, “Imag” and “tan” values within these table columns correspond to the dielectric properties of the samples tested including Quality Factor, Bandwidth of resonator relative to its center frequency, Dielectric Constant (real part of Permittivity related to energy stored within the sample), imaginary part of Permittivity (related to dissipative energy loss within the sample), and Loss Tangent, respectively.

TABLE 12
Formulation 1

| Freq | | | | | |
|---|---|---|---|---|---|
| (GHz) | Q | dB | Real | Imag | Tan Δ |
| 0.395203 | 2511.108154 | −59.687458 | 2.359240 | 0.013209 | 0.005599 |
| 1.185878 | 3685.500488 | −47.098541 | 2.351275 | 0.012117 | 0.005153 |
| 1.976559 | 4377.454102 | −42.687607 | 2.347592 | 0.010434 | 0.004444 |
| 2.767219 | 4813.814453 | −40.359413 | 2.345381 | 0.011313 | 0.004824 |
| 3.557982 | 5165.449249 | −37.519249 | 2.346201 | 0.011174 | 0.004763 |

TABLE 13
Formulation 2

| Freq | | | | | |
|---|---|---|---|---|---|
| (GHz) | Q | dB | Real | Imag | Tan Δ |
| 0.393560 | 2656.064941 | −59.616451 | 2.024708 | 0.003359 | 0.001659 |
| 1.180941 | 4084.051514 | −46.346390 | 2.022577 | 0.004430 | 0.002190 |
| 1.968324 | 4853.128418 | −42.209503 | 2.021898 | 0.003821 | 0.001890 |
| 2.755682 | 5396.391113 | −39.471050 | 2.023115 | 0.004357 | 0.002153 |
| 3.543270 | 4708.005859 | −38.121395 | 2.020302 | 0.007790 | 0.003856 |

TABLE 14
Formulation 3

| Freq | | | | | |
|---|---|---|---|---|---|
| (GHz) | Q | dB | Real | Imag | Tan Δ |
| 0.394134 | 2821.152100 | −59.240185 | 1.714324 | 0.002792 | 0.001629 |
| 1.182653 | 4375.402832 | −45.689976 | 1.713100 | 0.002900 | 0.001693 |
| 1.971184 | 5035.492188 | −41.710552 | 1.710197 | 0.003216 | 0.001881 |
| 2.759668 | 5789.505371 | −38.843452 | 1.711210 | 0.003156 | 0.001844 |
| 3.548205 | 6238.128418 | −35.792034 | 1.716711 | 0.003246 | 0.001892 |

TABLE 15
Formulation 4

| Freq | | | | | |
|---|---|---|---|---|---|
| (GHz) | Q | dB | Real | Imag | Tan Δ |
| 0.394666 | 2709.496826 | −58.818451 | 1.864798 | 0.006314 | 0.003386 |
| 1.184245 | 4446.962891 | −45.520187 | 1.863219 | 0.003120 | 0.001674 |
| 1.973816 | 5406.033203 | −41.020607 | 1.862792 | 0.002285 | 0.001227 |
| 2.763355 | 6072.073242 | −38.422489 | 1.863918 | 0.003066 | 0.001645 |
| 3.553214 | 6581.046875 | −35.589695 | 1.853659 | 0.003156 | 0.001703 |

While the preferred embodiments of the present invention have been illustrated in detail, it should be apparent that modifications and adaptations to those embodiments may occur to one skilled in the art without departing from the scope of the present invention.

I claim:

1. A method to prepare an oligomer comprising a plurality of pendent alkenyl groups, comprising:
reacting a copolymer formed by copolymerizing styrene and allyl alcohol comprising a polyhydroxy oligomer wherein n is between about 3 and about 50, and having a structure: 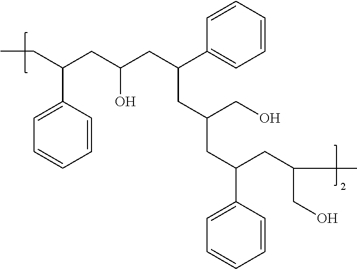
with an isocyanate having a structure: 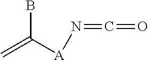
to give a urethane-modified copolymer having a structure: 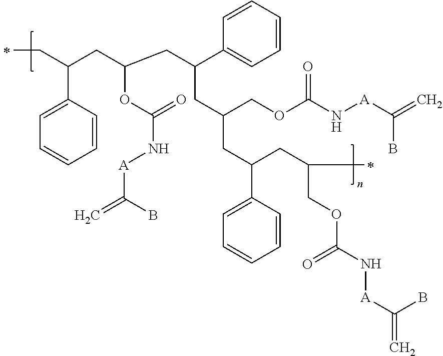
wherein A is selected from the group consisting of substituted phenyl and —CO—O—CH₂—CH₂—, and wherein B is alkyl.

2. The method of claim 1, wherein said isocyanate comprises isocyanatomethylmethacrylate.

3. The method of claim 1, wherein said isocyanate comprises isocyanatoethylmethacrylate.

3. The method of claim 1, wherein said isocyanate comprises dimethyl meta-isopropenyl benzyl isocyanate (5).

4. A formulation, comprising:
MONOMER (1) at about 31 weight percent;
MONOMER (2) at about 26 weight percent;
polystyrene-co-allyl alcohol (3) at about 25 weight percent about; and
dimethyl meta-isopropenyl benzyl isocyanate (5) at about 18 weight percent.

5. A formulation, comprising:
MONOMER (1) at about 21 weight percent;
MONOMER (2) at about 18 weight percent;
OLIGOMER (3) at about 17 weight percent;
ISOCYANATE (5) at about 12 weight percent;
MALEIMIDE (8), wherein R3=PHENYL at about 13 weight percent;
MALEIMIDE (8) wherein R3=HYDROGEN at about 6 weight percent; and
Tris (2-hydroxyethyl) isocyanurate triacrylate (9) at about 12 weight percent.

6. A resin formed by thermal cure of the formulation of claim 5.

7. A resin formed by photocure of the formulation of claim 5.

8. A formulation, comprising:
MONOMER (1) at about 19 weight percent;
MONOMER (2) at about 16 weight percent;
OLIGOMER (3) at about 15 weight percent;
ISOCYANATE (5) at about 11 weight percent;
MALEIMIDE (8), wherein R3=PHENYL at about 10 weight percent;
MALEIMIDE (8) wherein R3=HYDROGEN at about 5 weight percent; and
a substituted lactam (9) having a structure:

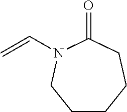

9. A resin formed by polymerization of the formulation of claim 8, wherein:
said resin comprises a dielectric constant of 2.7; and
said resin further comprises a 10 GHz loss tangent of 0.00238.

10. A polymer, formed by:
reacting diol (14) with isocyanate (5) to give a compound having a structure: 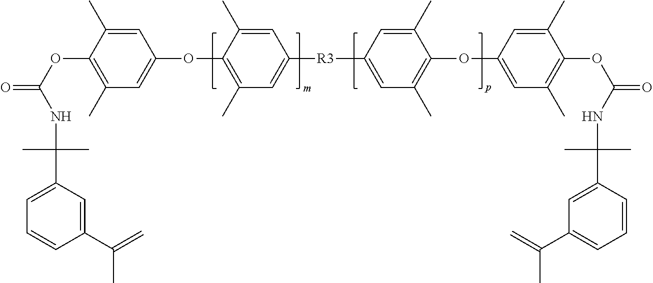
wherein m is greater than 1 and less than about 100,000, and wherein p is greater than 1 and less than about 100,000, and wherein R3 is selected from the group consisting of alkyl, aryl, and oxyalkyl.

11. A polymer, formed by:
reacting polycarbonate diol (16) with isocyanate (5) to give a polycarbonate diol comprising alkenyl end groups, and having a structure: 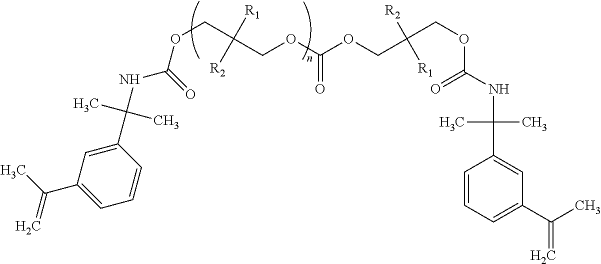
wherein R1 is selected from the group consisting of H and NH-Alkyl, and wherein R2 is alkyl, and wherein n is greater than 1 and less than about 50.

12. A formulation, comprising:
the polycarbonate diol comprising alkenyl end groups of claim 11 at about 31 weight percent;
MONOMER (1) at about 28 weight percent;
MONOMER (2) at about 19 weight percent;
MALEIMIDE (8), wherein R3=PHENYL at about 11 weight percent;
MALEIMIDE (8) wherein R3=HYDROGEN at about 11 weight percent.

13. A resin formed by polymerization of the formulation of claim 12, wherein:
said resin comprises a dielectric breakdown strength of 222 kV/mm; and
said resin further comprises a 10 GHz loss tangent of 0.0017.

14. A formulation, comprising:
MONOMER (1) at about 26 weight percent;
MONOMER (2) at about 18 weight percent;
MALEIMIDE (8), wherein R3=PHENYL at about 11 weight percent;
MALEIMIDE (8) wherein R3=HYDROGEN at about 10 weight percent; and
caprolactone acrylate (26) at about 35 weight percent, and comprising a structure:

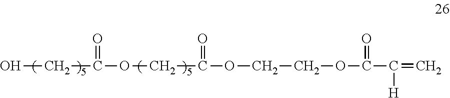

15. A resin formed by polymerization of the formulation of claim 14, wherein:
said resin comprises a dielectric breakdown strength of 90 kV/mm; and
said resin further comprises a 10 GHz loss tangent of 0.0137.

16. A method to prepare a compound having a structure: 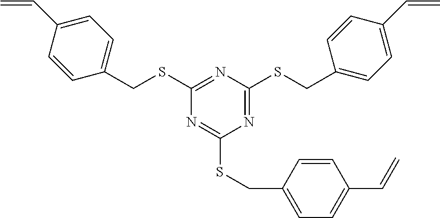 [SMILES: C=Cc1ccc(CSc2nc(SCc3ccc(C=C)cc3)nc(SCc3ccc(C=C)cc3)n2)cc1]
by reacting trimercaptotriazine with three equivalents of vinyl benzyl chloride.

17. The method of claim 16, further comprising conducting said reaction in an alcoholic KOH medium.

18. A method to prepare a compound having a structure: 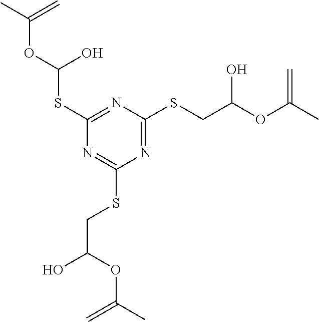 [SMILES: C=C(C)OC(O)CSc1nc(SCC(O)OC(=C)C)nc(SC(O)OC(=C)C)n1]
by reacting trimercaptotriazine with three equivalents of glycidylmethacrylate.

19. The method of claim 18, further comprising using a tertiary amine catalyst.

20. A method to prepare a compound having a structure: 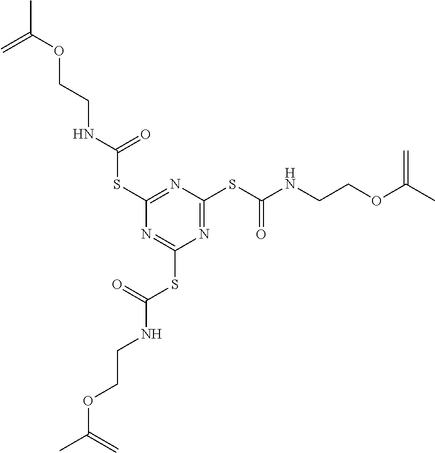 [SMILES: C=C(C)OCCNC(=O)Sc1nc(SC(=O)NCCOC(=C)C)nc(SC(=O)NCCOC(=C)C)n1]
by reacting trimercaptotriazine with three equivalents of 2-isocyanatomethylmethacrylate.

21. A formulation, comprising:
phenylmaleimide;
maleimide'
tert-butylstyrene; and
a tri-substituted triazine having a structure:

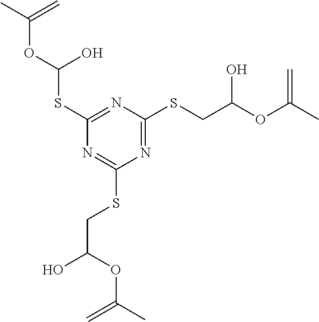 [SMILES: C=C(C)OC(O)CSc1nc(SCC(O)OC(=C)C)nc(SC(O)OC(=C)C)n1]

22. The formulation of claim 21, wherein:
said phenylmaleimide is present at about 24 weight percent;
said maleimide is present at about 12 weight percent;
said tert-butylstyrene is present at about 43 weight percent; and
said tri-substituted triazine is present at about 20 weight percent.

23. A resin formed by polymerizing the formulation of claim 22, comprising:
a Dielectric Constant of about 2.36 at a frequency of about 0.305 Gigahertz;
a Dielectric Constant of about 2.35 at a frequency of about 1.19 Gigahertz;
a Dielectric Constant of about 2.348 at a frequency of about 2.0 Gigahertz;
a Dielectric Constant of about 2.345 at a frequency of about 2.76 Gigahertz;
a Dielectric Constant of about 2.346 at a frequency of about 3.56 Gigahertz.

24. The resin of claim 23, comprising:
a Loss Tangent of about 0.0056 at a frequency of about 0.305 Gigahertz;
a Loss Tangent of about 0.0051 at a frequency of about 1.19 Gigahertz;
a Loss Tangent of about 0.0044 at a frequency of about 2.0 Gigahertz;
a Loss Tangent of about 0.0048 at a frequency of about 2.76 Gigahertz;
a Loss Tangent of about 0.0047 at a frequency of about 3.56 Gigahertz.

25. The formulation of claim 21, wherein:
said phenylmaleimide is present at about 27 weight percent;
said maleimide is present at about 14 weight percent;
said tert-butylstyrene is present at about 48 weight percent; and
said tri-substituted triazine is present at about 10 weight percent.

26. A resin formed by polymerizing the formulation of claim 25, comprising:
a Dielectric Constant of about 2.024 at a frequency of about 0.305 Gigahertz;
a Dielectric Constant of about 2.022 at a frequency of about 1.19 Gigahertz;
a Dielectric Constant of about 2.021 at a frequency of about 2.0 Gigahertz;
a Dielectric Constant of about 2.023 at a frequency of about 2.76 Gigahertz;
a Dielectric Constant of about 2.020 at a frequency of about 3.56 Gigahertz.

27. The resin of claim 26, comprising:
a Loss Tangent of about 0.0017 at a frequency of about 0.305 Gigahertz;
a Loss Tangent of about 0.0022 at a frequency of about 1.19 Gigahertz;
a Loss Tangent of about 0.0019 at a frequency of about 2.0 Gigahertz;
a Loss Tangent of about 0.0022 at a frequency of about 2.76 Gigahertz;
a Loss Tangent of about 0.0039 at a frequency of about 3.56 Gigahertz.

28. The formulation of claim 21, wherein:
said phenylmaleimide is present at about 28 weight percent;
said maleimide is present at about 14 weight percent;
said tert-butylstyrene is present at about 52 weight percent; and
said tri-substituted triazine is present at about 6 weight percent.

29. A resi/.n formed by polymerizing the formulation of claim 28, comprising:
a Dielectric Constant of about 1.71 at a frequency of about 0.305 Gigahertz;
a Dielectric Constant of about 1.71 at a frequency of about 1.19 Gigahertz;
a Dielectric Constant of about 1.71 at a frequency of about 2.0 Gigahertz;
a Dielectric Constant of about 1.71 at a frequency of about 2.76 Gigahertz;
a Dielectric Constant of about 1.72 at a frequency of about 3.56 Gigahertz.

30. The resin of claim 29, comprising:
a Loss Tangent of about 0.0016 at a frequency of about 0.305 Gigahertz;
a Loss Tangent of about 0.0017 at a frequency of about 1.19 Gigahertz;
a Loss Tangent of about 0.0018 at a frequency of about 2.0 Gigahertz;
a Loss Tangent of about 0.0018 at a frequency of about 2.76 Gigahertz;
a Loss Tangent of about 0.0019 at a frequency of about 3.56 Gigahertz.

31. The formulation of claim 21, wherein:
said phenylmaleimide is present at about 29 weight percent;
said maleimide is present at about 15 weight percent;
said tert-butylstyrene is present at about 51 weight percent; and
said tri-substituted triazine is present at about 5 weight percent.

32. A resin formed by polymerizing the formulation of claim 31, comprising:
a Dielectric Constant of about 2.36 at a frequency of about 0.305 Gigahertz;
a Dielectric Constant of about 2.35 at a frequency of about 1.19 Gigahertz;
a Dielectric Constant of about 2.348 at a frequency of about 2.0 Gigahertz;
a Dielectric Constant of about 2.345 at a frequency of about 2.76 Gigahertz;
a Dielectric Constant of about 2.346 at a frequency of about 3.56 Gigahertz.

33. The resin of claim 32, comprising:
a Loss Tangent of about 0.0056 at a frequency of about 0.305 Gigahertz;
a Loss Tangent of about 0.0051 at a frequency of about 1.19 Gigahertz;
a Loss Tangent of about 0.0044 at a frequency of about 2.0 Gigahertz;
a Loss Tangent of about 0.0048 at a frequency of about 2.76 Gigahertz;
a Loss Tangent of about 0.0047 at a frequency of about 3.56 Gigahertz.
